(19) United States
(12) Patent Application Publication
(10) Pub. No.: US 2009/0203408 A1
(43) Pub. Date: Aug. 13, 2009

(54) User Interface with Multiple Simultaneous Focus Areas

(75) Inventors: Gregory J. Athas, Lisle, IL (US); Michael Zolfo, North Aurora, IL (US); Olga Gerchikov, Buffalo Grove, IL (US); Pawel Bak, Elmwood Park, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NOVARRA, INC.

(21) Appl. No.: 12/366,447

(22) Filed: Feb. 5, 2009

Related U.S. Application Data
(60) Provisional application No. 61/027,159, filed on Feb. 8, 2008.

(51) Int. Cl. H04M 1/00

(52) U.S. Cl. 455/566

(57) ABSTRACT

The present application relates to a system and method for a user interface for key-pad driven devices, such as mobile phones. The user interface provides an ability to control two simultaneous focus elements on a display screen at once. Each focus element can be controlled by a separate set of keys, for example. Each focus element may be included within separate control content areas of the user interface.

### CROSS-REFERENCE TO RELATED APPLICATION

The present patent application claims priority under 35 U.S.C. § 119(e) to U.S. Provisional Patent Application Ser. No. 61/027,159, filed on Feb. 8, 2008, the entire contents of which are incorporated herein by reference as if fully set forth in this description.

### FIELD

The present application relates generally to the field of graphical user interfaces and network communications. More specifically, the application relates to a system and method for a user interface for key-pad driven devices, such as mobile phones for example. The user interface may provide two simultaneous focus elements on a display screen at once, and each focus element can be controlled by a separate set of keys, for example.

### BACKGROUND

Many technological innovations rely upon a user interface design to lesson technical complexity of a product. Technology alone may not win user acceptance and subsequent marketability, but rather, a user's experience, or how the user experiences an end product, may be the key to acceptance. When applied to computer software, a user interface design enables human to computer interaction.

In wireless communication devices, functions are primarily controlled by using a keyboard, and information is displayed to a user using a display. Some devices may be provided with particular browser keys, which are usually implemented as mechanical keys that can be pressed to select a following or preceding alternative. A user presses a key to select a desired control function that is indicated by providing a command of the function in writing or a symbol illustrating the same in the display in a vicinity of the key. A user typically interacts with controls or displays of a computer or computing device through a user interface.

In typical user interfaces for mobile phones, for example, a user has control of only one interface at any given time. For example, a user may initiate a client browser to load a web page, and thus, the user would only be able to use keys on the mobile phone to navigate within the web page. To navigate or utilize other functions on the mobile phone, the user would need to exit out of or close the client browser to enable selection of another application using the keys on the mobile phone. Thus, while any given interface application is running on the mobile phone, the keys on the mobile phone only operate to navigate within the one interface application.

### SUMMARY

In the present application, a mobile phone is provided that includes a computer-readable medium containing a set of instructions for causing a processing unit to perform the functions of displaying a main content area on a display screen of the mobile phone that includes a focus element, and at the same time as displaying the main content area on the display screen of the mobile phone, displaying a control content area on the display screen of the mobile phone that include selectable icons. The functions further include providing a first input function for enabling movement between and action upon the focus element contained in the main content area while not affecting movement between or action upon the selectable icons contained in the control content area, and providing a second input function for enabling movement between and action upon the selectable icons contained in the control content area while not affecting movement between or action upon the focus element contained in the main content area.

In another aspect, a mobile phone is provided that includes a computer-readable medium containing a set of instructions for causing a processing unit to perform the functions of displaying a first control content area and a second control content area on a screen of the mobile phone, and providing a first key on the mobile phone for controlling movement between and action upon elements in the first control content area and a second key on the mobile phone for controlling movement between and action upon elements in the second control content area. The first key and the second key enable simultaneous control of the first control content area and the second control content area, respectively. The functions further includes controlling movement between and action upon elements in the second control content area based on a received command from the second key by sliding selectable icons left or right within the second control content area to position a desired icon in a focus position of the second control content area.

In still another aspect, a mobile phone is provided that includes a processor that receives inputs from a first input interface and a second input interface, and memory containing a set of instructions executable by the processor to perform the functions of: (i) displaying a main content area on a display screen of the mobile device that includes a focus element; (ii) at the same time as displaying the main content area on the display screen of the mobile device, displaying a control content area on the display screen of the mobile phone that include selectable icons; (iii) receiving inputs from the first input interface for controlling movement between and action upon the focus element contained in the main content area while not affecting movement between or action upon the selectable icons contained in the control content area, and (iv) receiving inputs from the second input function for controlling movement between and action upon the selectable icons contained in the control content area while not affecting movement between or action upon the focus element contained in the main content area.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example front view of a computing device with multiple content areas.

FIG. 2 is an example front view of another computing device with multiple content areas.

FIG. 3 illustrates an example conceptual display screen of a computing device.

FIGS. 4A-4B illustrate more example conceptual display screens of a computing device.

FIGS. 5A-5B illustrate still further example computing devices.

### DETAILED DESCRIPTION

The present application provides a user interface including multiple content areas on one display within which a user may navigate simultaneously. Separate control keys or functions may be provided for each content area to enable interaction within the content areas. For example, a left softkey may control display of one content area, such as to include a menu of actions for a current web page displayed in the content area, and a right softkey may be context sensitive, for example, and may control functions including back, zoom, etc. in another content area.

Portable computing devices, or mobile phones for example, usually include keyboards that contain keys for moving a cursor up, down, to the left, or to the right on the display. A user may control the cursor on the mobile phone in the same way that a user controls a cursor on a personal computer using a mouse, for example. Other keys may be used for selecting functions on a display of the devices. Corresponding functions of a mouse may also be possible using a touch screen for controlling the cursor. According to the present application, using any of these types of control features may enable the user to interact with multiple content areas of a display simultaneously.

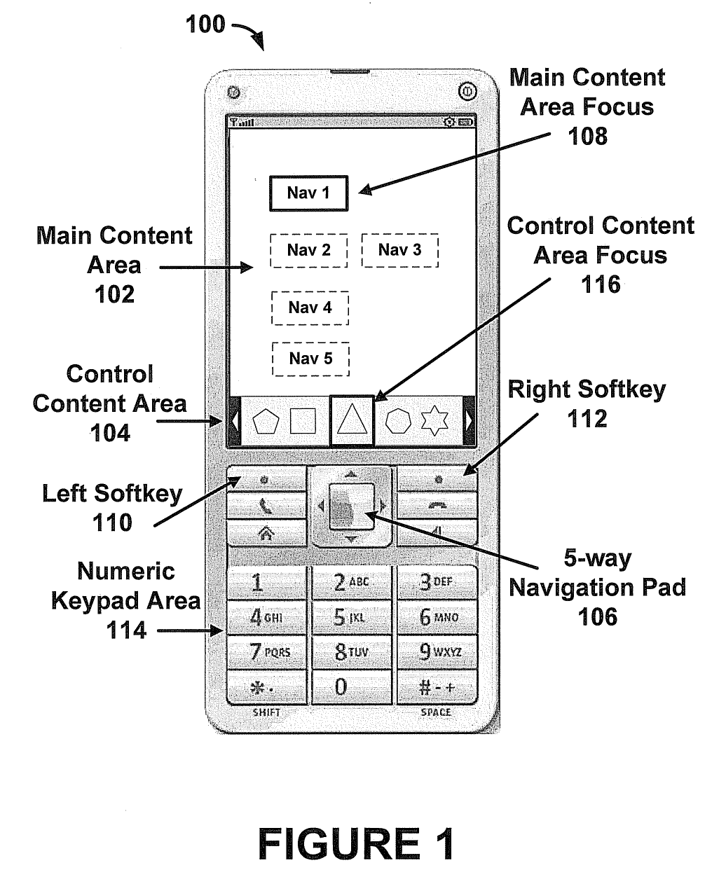

Referring now to FIG. 1, an example front view of a computing device 100 is illustrated. The computing device 100 is in the form of a mobile phone, however, features of the present application apply to computing devices in general and are not limited solely to mobile phones. The computing device 100 includes a display screen that is divided into a main content area 102 and a control content area 104. A 5-way navigation pad 106 is provided to enable moving between and acting upon user interface elements contained in the main content area 102. For example, the 5-way navigation pad 106 enables navigation between elements labeled Nav 1, Nav 2, Nav 3, Nav 4 and Nav 5, and an element which is currently selected is referred to as a main content area focus 108. Selection of an element may refer to the element upon which a cursor currently is positioned, for example, and is shown in FIG. 1 by a bold border line.

In addition, the main content area 102 may include content that extends beyond the displayable area (e.g., window) of the computing device 100, and the 5-way navigation pad 106 enables scrolling both in a horizontal and vertical fashion within the main content area 102. Thus, the 5-way navigation pad 106 enables navigation between elements that are not in the displayable area resulting in the main content area 102 scrolling to display the elements while the control content area 104 may remain fixed in its display location.

The 5-way navigation pad 106 may not enable navigation within the control content area 104. The control content area 104 may be manipulated via a left softkey 110 and a right softkey 112. Of course, a user may program any of the keys of the computing device 100, such as any of the 5-way navigation pad 106, the left softkey 110, the right softkey 112, or any keys of a numeric keypad area 114, to be used for interfacing with either the main content area 102 or the control content area 104. It may be, however, that a key can only perform as a navigation key for one content area at a time so that a user will use at least two different keys in order to navigate both the main content area 102 and the control content area 104 at the same time.

The left softkey 110 and the right softkey 112 refer to keys below the display screen on the computing device 100 that are not contained within the numeric keypad 114, and perform a special function on the computing device 100. The left softkey 110 and the right softkey 112 are positioned on either side of the 5-way navigation pad 106, or alternatively, the 5-way navigation pad 106 is positioned between the left softkey 110 and the right softkey 112. The left softkey 110 and the right softkey 112 permute or enable navigation between elements contained in the control content area 104 by sliding elements left or right to position an element in a center position. The center position is a control content area focus 116, however, other positions besides the center position could also be programmed to be the control content area focus position, for example. When a user selects the focus 116, an application designated by an icon of the focus 116 will be executed.

Using this configuration, a user may navigate through and within the main content area 102 using the 5-way navigation pad 106, and at the same time, a user may navigate within the control content area 104 using either the left softkey 110, the right softkey 112 or both. The computing device 100 is provided with a graphical user interface (GUI) that enables simultaneous navigation capabilities, for example, within the main content area 102 and the control content area 104. In one example, the main content area 102 and the control content area 104 may be a single graphical user interface within which the left softkey 110 and the right softkey 112 are reserved for switching content screens, and the 5-way navigation pad 106 enables interacting within the screens. For example, the left softkey 110 may control display of the control content area 104 as well as include a menu of actions for a current web page displayed in the main content area 102. The right softkey 112 may be context sensitive, for example, and may control functions including back, zoom, etc.

Alternatively, the computing device 100 may include multiple graphical user interfaces where the main content area 102 comprises a first graphical user interface, and the control content area 104 comprises a second graphical user interface. The computing device 100 can then allow a user to use both the first and second graphical user interfaces at the same time, and the user can navigate through each individually using different keys on the computing device 100 that are designated for use with one of the graphical user interfaces, for example.

Whether a display on the computing device 100 is provided by one or two GUIs, at least two content control areas will be provided. Thus, a user may navigate within the main content area 102 independently of the control content area 104, for example, and a user may do so at the same time, if desired, using separate or different keys for each navigation. The computing device 100 thus provides the opportunity for a user to have multiple focus areas on the same display screen at same time.

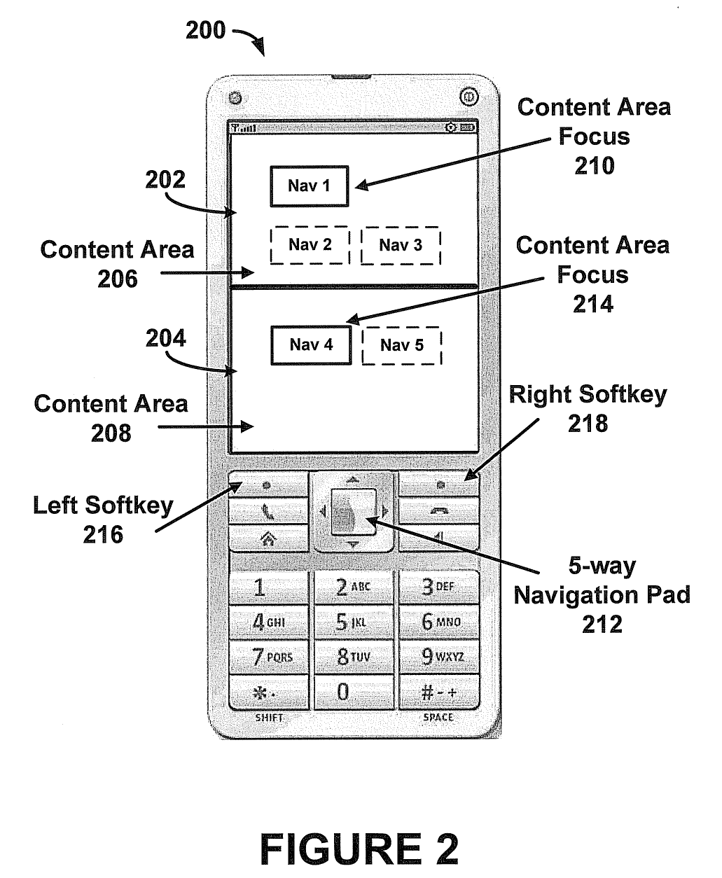

FIG. 2 is an example front view of another computing device 200 that includes a first graphical user interface 202 and a second graphical user interface 204. The first graphical user interface 202 includes a content area 206 and the second graphical user interface 204 includes a content area 208. A user may navigate within the content area 206 of the first graphical user interface 202 so as to move a cursor to a content area focus position 210 using a 5-way navigation pad 212. Similarly, a user may navigate within the content area 208 of the second graphical user interface 204 so as to move a cursor to a content area focus position 214 using a left softkey 216 or a right softkey 218. Because the computing device 200 includes two graphical user interfaces, a user may navigate within either interface independent of operation in the other interface. Further, a user may navigate within both the first graphical user interface 202 and the second graphical user interface 204 at the same time, by using both the 5-way navigation pad 212 and either the left softkey 216 or the right softkey 218.

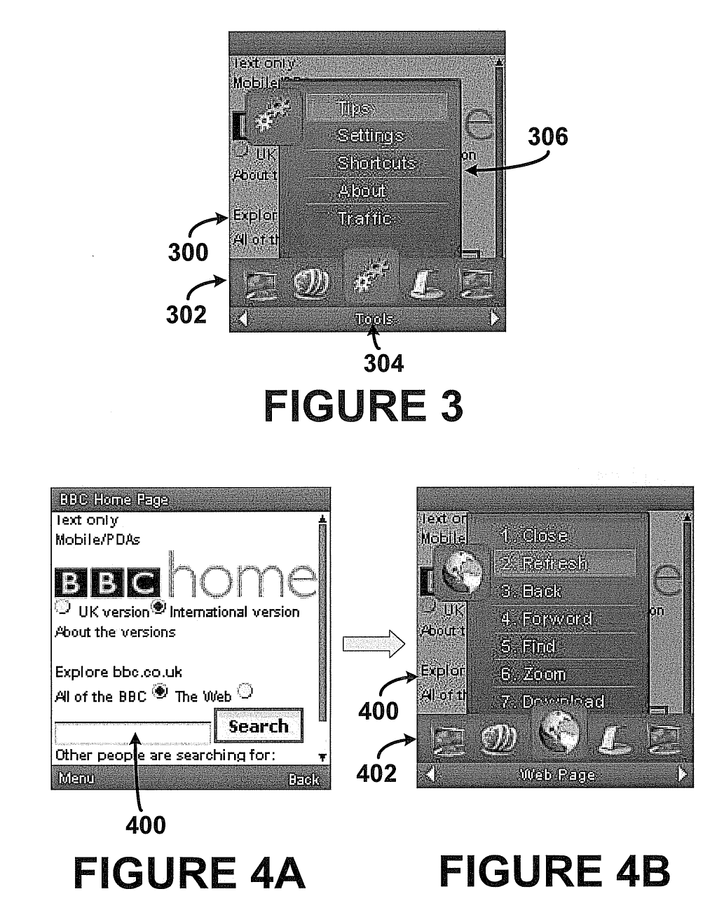

FIG. 3 illustrates another example conceptual display screen of a computing device 300 that includes a main content area 300 and a control content area 302, which may each be a part of one graphical user interface or each may comprise an individual graphical user interface. In this example, when a control content area focus 304 is highlighted, a menu 306 is presented to a user including choices such as tips, settings, shortcuts, about, traffic, etc. The menu 306 may be context sensitive depending on which icon within the control content area 302 is highlighted. As shown, the menu 306 may be displayed over a portion of the main content area 300. When the menu 306 is displayed, for example, control of the main content area 300 could be disabled, and movement between and action upon items in the menu 306 may be performed using the 5-way navigation pad key which may only be designated for navigation within the main content area 300. As another example, a separate key, which does not provide navigation functions for either of the main content area 300 or the control content area 302 may be designated for navigating within the menu 306, so that navigation within the main content area 300 or the control content area 302 can still proceed when the menu 306 is displayed.

Further, as a user scrolls through icons in the control content area 302, a description of a function of a highlighted icon may be provided, such as shown in FIG. 3, where a “tools” function is highlighted.

As shown in FIG. 3, the control content area 302 may be positioned at a bottom of a display screen, and may include selectable icons. Each icon designates an action or application that is executed upon selection of the icon. A user can use a designated key on the mobile phone to scroll through the selectable icons by sliding the icons left or right until a desired icon is in the control content area focus position 304. Once an icon is in the control content area focus position 304, a display of the icon may be enlarged, as shown in FIG. 3 with the “tools” icon.

The icons within the control content area 302 may correspond to actions that may be performed in the main content area 300, such as zoom, back, forward, etc. Further, as a user navigates within the main content area 300 and changes or executes different applications within the main content area 300, icons within the control content area 302 may adjust to designate action or applications associated with or that may be performed within or by an application running in the main content area 300, for example.

The control content area 300 may be hidden from display when not being actively used, resulting in the main content area 302 occupying the entire display screen. Pressing either the left softkey or the right softkey (as described above with respect to FIG. 1) will return the control content area 302 to the display and resize the main content area 300 display window accordingly. For example, FIG. 4A illustrates an example conceptual display screen of a computing device in which initially only a main content area 400 is displayed on the display screen. However, once either a left softkey or a right softkey is pressed, a control content area 402 returns to the display screen, as shown in FIG. 4B. The control content area 402 may be hidden after a period of inactivity due to non-use of the left softkey or right softkey, or due to non-receipt of a command from the left softkey or right softkey over a given period of time.

Similarly, actions performed on main content area 400 elements may cause the control content area 402 to react accordingly. For instance, entering a web address into a text field in the main content area 400 may cause the control content area 402 to switch to a different element and perform a related action.

In one example, multiple simultaneous main content areas 400 can be coexisting and a control content area 402 can be used to select which main content area is visible. For example, if multiple windows of a micro-browser on a mobile phone are opened and displayed in the main content area 400, a user may use icons within the control content area 402 to select which window is visible, or to select which window is displayed in a forefront of the main content area.

Alternatively, a user may only be able to navigate within either the control content area 402 or the main content area 400 at a given time. For example, as shown in FIG. 4B, once either the left softkey or the right softkey is pressed, the control content area 402 returns to the display screen and the user may only be able to navigate within the control content area 402 while the control content area 402 is displayed. The main content area 400 may be set to a background while icons and menus of the control content area 402 are brought to a foreground. A user may then switch control back to the main content area 400 by pressing a key designated for control and navigation within the main content area 400, such as the 5-way navigation key. Thus, the keys on the computing device may control which content area is brought to focus. However, as mentioned above, a user may be able to simultaneously navigate within both the main content area 400 and the control content area 402 at the same time, if desired, using separate keys for navigating within the main content area 400 and the control content area 402, respectively.

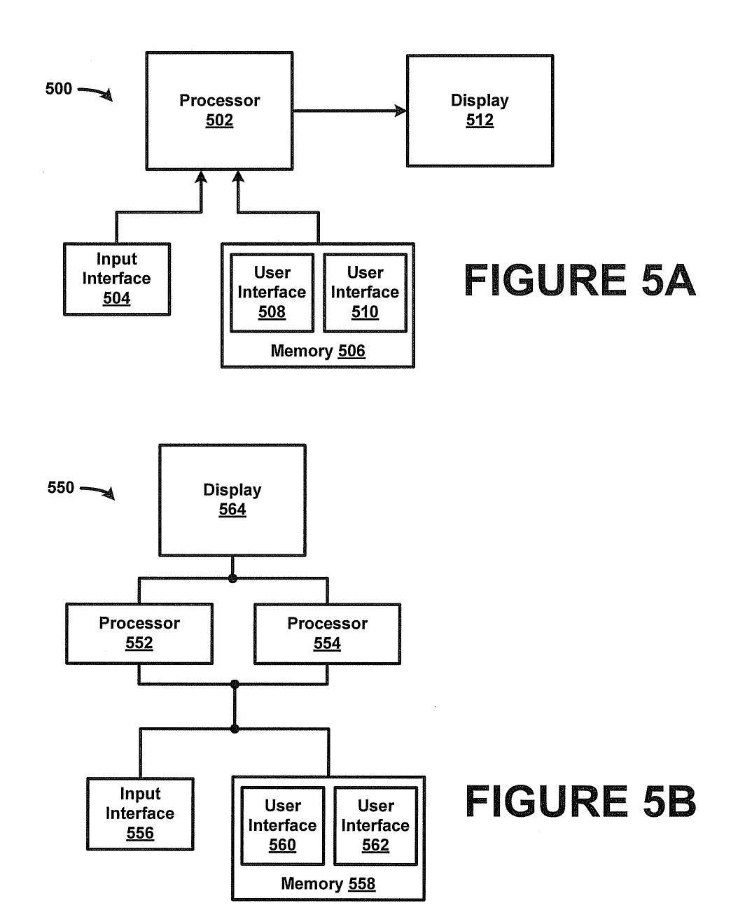

FIGS. 5A-5B illustrate example computing devices that operate according to the present application. FIG. 5A illustrates an example computing device 500 that includes a processor 502 that receives inputs from an input interface 504, and may access memory 506 to execute applications, such as to execute machine language instructions to perform functions of user interfaces 508 and 510. The processor 502 outputs to a display 512.

In general, it should be understood that the computing device 500 could include hardware objects developed using integrated circuit development technologies, or the combination of hardware and software objects that could be ordered, parameterized, and connected in a software environment to implement different functions described herein. Also, the hardware objects could communicate using electrical signals, with states of the signals representing different data. It should also be noted that the computing device 500 generally executes application programs resident at the computing device 500 under the control of an operating system. The application programs, such as a client browser, may be stored on memory within the computing device 500 and may be provided using machine language instructions or software with object-oriented instructions, such as the Java programming language. However, other programming languages (such as the C++ programming language for instance) could be used as well. The computing device 500 may also include other components (not shown), such as a receiver, a transmitter a microphone, and an audio block for converting a microphone signal from analog to digital form, and for converting a signal to be transmitted to the receiver from digital to analog form, for example.

The computing device 500 may be an electronic device including any of a wireless telephone, personal digital assistant (PDA), hand-held computer, and a wide variety of other types of electronic devices that might have navigational capability (e.g., keyboard, touch screen, mouse, etc.) and an optional display for viewing downloaded information content. Furthermore, the computing device 500 can include any type of device that has the capability to utilize speech synthesis markups such as W3C (www.w3.org) Voice Extensible Markup Language (VoiceXML). One skilled in the art of computer systems will understand that the example embodiments are not limited to any particular class or model of computer employed for the computing device 500 and will be able to select an appropriate system.

Thus, the computing device 500 generally can range from a hand-held device, laptop, or personal computer. One skilled in the art of computer systems will understand that the present example embodiments are not limited to any particular class or model of computer employed for the computing device 500 and will be able to select an appropriate system.

The processor 502 may be embodied as a processor that accesses internal (or external) memory, such as the memory 506, to execute software functions stored therein. One skilled in the art of computer systems design will understand that the example embodiments are not limited to any particular class or model of processor. The processor 502 may operate according to an operating system, which may be any suitable commercially available embedded or disk-based operating system, or any proprietary operating system. Further, the processor 502 may comprise one or more smaller central processing units, including, for example, a programmable digital signal processing engine or may also be implemented as a single application specific integrated circuit (ASIC) to improve speed and to economize space. In general, it should be understood that the processor 502 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data.

The processor 502 may further comprise, for example, a micro controller unit (MCU) and a programmable logic circuit (ASIC, Application Specific Integrated Circuit), and may execute software to perform functions of a wireless communication device, such as reception and transmission functions, and I/O functions (Input/Output).

The input interface 504 may include a keyboard, a trackball, and/or a two or three-button mouse function, if so desired. The input interface 504 is not, however, limited to the above presented kind of input means, and the input interface 504 can comprise for example several display elements, or merely a touch screen. Further, the input interface 504 may include multiple input functions, or multiple input interfaces, such as a keypad, a touchscreen, etc., depending on the type of computing device 500, for example.

The memory 506 may include a computer readable medium. Computer readable medium may refer to any medium that participates in providing instructions to a processor unit for execution. Such a medium may take many forms, including but not limited to, non-volatile media, and transmission media. Non-volatile media include, for example, optical or magnetic disks, such as storage devices. Volatile media include, for example, dynamic memory, such as main memory or random access memory (RAM). Common forms of computer readable media include, for example, floppy disks, flexible disks, hard disks, magnetic tape, punch cards, CD-ROM, a RAM, a PROM, an EPROM, a FLASH-EPROM, and any other memory chip or cartridge, or any other medium from which a computer can read.

The user interfaces 508 and 510 may be embodied as a module, a segment, or a portion of program code, which includes one or more instructions executable by the processor 502 for implementing specific logical functions or steps. The program code may be stored on any type of computer readable medium, for example, such as a storage device including a disk or hard drive.

In one example, the processor 502 executes software or machine language instructions stored in the memory 506 to perform the functions of the user interfaces 508 and 510. Thus, the processor 502 uses software to create specialized interfaces on the display 512. Each user interface 508 and 510 may be displayed simultaneously on the display 512, and each may be displayed on only a portion of the display 512. A user may navigate within each user interface 508 and 510 separately using respective keys or input functions of the input interface 504. According to one example, when the user interface software 508 and 510 is executed, the processor 502 instructs the display 512 to display a graphical user interface (GUI) that includes multiple content control areas for independent control by a user. Alternatively, the processor 502 may instruct the display 512 to display multiple graphical user interfaces that each include a content control area, and each GUI may be independently controlled by the user.

The user interfaces 508 and 510 may be of a standard type of user interface allowing a user to interact with a computer that employs graphical images in addition to text to represent information and actions available to the user. Actions may be performed through direct manipulation of graphical elements, which include windows, buttons, menus, and scroll bars, for example.

The user interfaces 508 and 510 may include either Java or HTML content, for example. A Java page may be programmed into the computing device 500 for specialized actions, while HTML content may include dynamic content (e.g., web pages, clips, widgets). Content control areas of the GUIs produced by execution of the user interfaces 508 and 510 can be configured using HTML (or XML), for example.

FIG. 5B is an alternate example computing device 550 that includes two processors, processor 552 and 554, that receive inputs from input interface 556, and execute software of machine language instructions stored in memory 558, such as user interface applications 560 and 562, and outputs to display 564. The computing device 550 may be similar to computing device 500, except that computing device 550 includes two processors, each of which may execute one of the user interface applications 560 and 562.

FIGS. 5A-5B illustrate example computing devices, however, many other configurations are possible as well that may perform functions of the present application.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. Thus, the various aspects and embodiments disclosed herein are for purposes of illustration and are not intended to be limiting, with the true scope and spirit being indicated by the following claims.

What is claimed is:

1. A mobile phone including a computer-readable medium containing a set of instructions for causing a processing unit to perform the functions of:
displaying a main content area on a display screen of the mobile phone that includes a focus element;
at the same time as displaying the main content area on the display screen of the mobile phone, displaying a control content area on the display screen of the mobile phone that include selectable icons;
providing a first input function for enabling movement between and action upon the focus element contained in the main content area while not affecting movement between or action upon the selectable icons contained in the control content area; and
providing a second input function for enabling movement between and action upon the selectable icons contained in the control content area while not affecting movement between or action upon the focus element contained in the main content area.

2. The mobile phone of claim 1, wherein the first input function includes a first key on the mobile phone, and the second input function includes a second key on the mobile phone, wherein the first key and the second key are different keys on the mobile phone.

3. The mobile phone of claim 2, further comprising instructions for causing the processing unit to perform the functions of enabling simultaneous movement between and action upon the focus element in the main content area with movement between and action upon the selectable icons in the control content area using the first key and the second key.

4. The mobile phone of claim 1, wherein the first key is a five-way navigation pad.

5. The mobile phone of claim 1, wherein the second input function includes a left softkey and a right softkey, wherein the left softkey and the right softkey enable movement between and action upon the selectable icons contained in the control content area by sliding the selectable icons left or right to position a desired icon in a focus position of the control content area.

6. The mobile phone of claim 5, wherein selection of the desired icon enables execution of an application designated by the desired icon.

7. The mobile phone of claim 5, further comprising instructions for causing the processing unit to perform the functions of displaying a menu pertaining to the desired icon when the desired icon is in the focus position.

8. The mobile phone of claim 7, further comprising instructions for causing the processing unit to perform the functions of displaying the menu over a portion of the main content area.

9. The mobile phone of claim 7, further comprising instructions for causing the processing unit to perform the functions of enabling movement between and action upon items in the menu using the first input function.

10. The mobile phone of claim 1, further comprising instructions for causing the processing unit to perform the functions of adjusting actions designated by the selectable icons within the control content area to correspond with actions that may be performed in the main content area.

11. The mobile phone of claim 1, further comprising instructions for causing the processing unit to perform the functions of:
identifying a period of inactivity within the control content area, wherein the period of inactivity is due to non-use of the second input function; and
removing a display of the control content area after identifying the period of inactivity within the control content area.

12. A mobile phone including a computer-readable medium containing a set of instructions for causing a processing unit to perform the functions of:
displaying a first control content area and a second control content area on a screen of the mobile phone;
providing a first key on the mobile phone for controlling movement between and action upon elements in the first control content area and a second key on the mobile phone for controlling movement between and action upon elements in the second control content area, wherein the first key and the second key enable simultaneous control of the first control content area and the second control content area, respectively; and
controlling movement between and action upon elements in the second control content area based on a received command from the second key by sliding selectable icons left or right within the second control content area to position a desired icon in a focus position of the second control content area.

13. The mobile phone of claim 12, wherein selection of the desired icon enables execution of an application designated by the desired icon.

14. The mobile phone of claim 12, wherein the first key is a five-way navigation pad, and the second key includes one of a left softkey or a right softkey.

15. The mobile phone of claim 14, wherein the 5-way navigation pad is positioned between the left softkey and the right softkey on the mobile phone.

16. The mobile phone of claim 12, wherein the first key only controls movement between and action upon elements in the first control content area, and wherein the second key only controls movement between and action upon elements in the second control content area.

17. The mobile phone of claim 12, wherein the first control content area includes multiple content displays, and wherein action upon elements in the second control content area selects one of the multiple content displays to be displayed in a forefront of the first control content area.

18. The mobile phone of claim 12, further comprising instructions for causing the processing unit to perform the functions of enlarging a display of an icon when the icon is positioned in the focus position of the second control content area.

19. A mobile phone comprising:
a processor that receives inputs from a first input interface and a second input interface; and
memory containing a set of instructions executable by the processor to perform the functions of: (i) displaying a main content area on a display screen of the mobile device that includes a focus element; (ii) at the same time as displaying the main content area on the display screen of the mobile device, displaying a control content area on the display screen of the mobile phone that include selectable icons; (iii) receiving inputs from the first input interface for controlling movement between and action upon the focus element contained in the main content area while not affecting movement between or action upon the selectable icons contained in the control content area, and (iv) receiving inputs from the second input function for controlling movement between and action upon the selectable icons contained in the control content area while not affecting movement between or action upon the focus element contained in the main content area.

20. The mobile phone of claim 19, wherein the main content area and the control content area comprise a single graphical user interface.

21. The mobile phone of claim 19, wherein the main content area comprises a first graphical user interface and the control content area comprises a second graphical user interface.
